(19) United States
(12) Patent Application Publication
(10) Pub. No.: US 2008/0237269 A1
(43) Pub. Date: Oct. 2, 2008

(54) DECORATIVE TRIGGER SPRAYER SHROUDS AND METHODS OF MAKING THE SAME

(76) Inventor: REBECCA A. HARNAR, Bates City, MO (US)

Correspondence Address: MEADWESTVACO CORPORATION, 1021 MAIN CAMPUS DRIVE, CENTENNIAL CAMPUS, RALEIGH, NC, 27606, US

(21) Appl. No.: 12/056,873

(22) Filed: Mar. 27, 2008

Related U.S. Application Data
(60) Provisional application No. 60/908,286, filed on Mar. 27, 2007.

(51) Int. Cl. B05B 1/02; B05B 11/00; B05B 9/01; B67D 5/42

(52) U.S. Cl. 222/383.1

(57) ABSTRACT

A trigger sprayer shroud having a decorative pattern such as a camouflage pattern, a wood grain pattern, a metal pattern, a rock pattern, a granite pattern, and a marble pattern, wherein the pattern may be formed on the shroud using a water-transfer process.

### CROSS-REFERENCE TO RELATED APPLICATIONS

This application claims the benefit of U.S. Provisional Application No. 60/908,286 entitled “DECORATIVE TRIGGER SPRAYER SHROUDS AND METHODS FOR MAKING THE SAME,” filed Mar. 27, 2007, and incorporates the same herein by reference in its entirety.

### BACKGROUND

1. Field of the Invention

The present invention relates to trigger sprayer shrouds and more particularly to trigger sprayer shrouds decorated with one or more decorations.

2. State of the Art

Trigger sprayer shrouds found on conventional trigger sprayer devices are generally formed by injection molding the trigger sprayer shroud. In most instances, the color of the trigger sprayer shroud is limited by the color of the resin or plastic used to mold the trigger sprayer shroud. In some instances, two colors of resin or plastic may be bi-injection molded to form a trigger sprayer shroud having two different colors. The formation of more than two colors in a trigger sprayer shroud may be prohibitively expensive and may be difficult to accomplish.

In an attempt to enhance the aesthetics of trigger sprayer shrouds, labels and decorative adhesive stickers have been applied to the trigger sprayer shrouds. While the adhesive stickers may provide decoration over a portion of a trigger sprayer shroud they typically do not cover the entire shroud. In addition, the use of adhesive stickers generally requires that the trigger sprayer shroud include a large flat portion upon which the sticker may be applied. The feasibility of providing an adhesive sticker over a curved portion of a trigger sprayer shroud is limited by automatic application equipment and costs.

Therefore, it may be advantageous to produce a trigger sprayer shroud with more than two colors. It may also be advantageous to provide a trigger sprayer shroud having a decorative pattern over the exterior surface of the trigger sprayer shroud. It may also be advantageous to provide a method for applying a decoration to a trigger sprayer shroud.

### BRIEF DESCRIPTION OF THE SEVERAL VIEWS OF THE DRAWINGS

While the specification concludes with claims particularly pointing out and distinctly claiming some embodiments which are regarded as the invention, the features of various embodiments of the invention can be more readily ascertained from the following detailed description of the invention when read in conjunction with the accompanying drawings in which:

FIGS. 1 through 3 illustrate a process for forming one or more patterns on a trigger sprayer shroud according to embodiments of an invention;

FIG. 4 illustrates a trigger sprayer shroud according to embodiments of the invention;

FIG. 5 illustrates a trigger sprayer according to embodiments of the invention; and

FIG. 6 illustrates a trigger sprayer according to embodiments of the invention.

### DETAILED DESCRIPTION OF THE INVENTION

According to particular embodiments of the invention, a conventional trigger sprayer shroud may be decorated using a water-transfer printing process. Any conventional water-transfer printing process may be used to transfer a design or decoration to one or more surfaces of a trigger sprayer shroud. In addition, the water-transfer printing process may be used to transfer any desired pattern or decoration onto one or more trigger sprayer shroud surfaces. For example, the water-transfer process may be used to transfer one or more wood grain patterns, camouflage patterns, stone patterns, marble patterns, metal patterns, or other decorative patterns to one or more surfaces of a trigger sprayer.

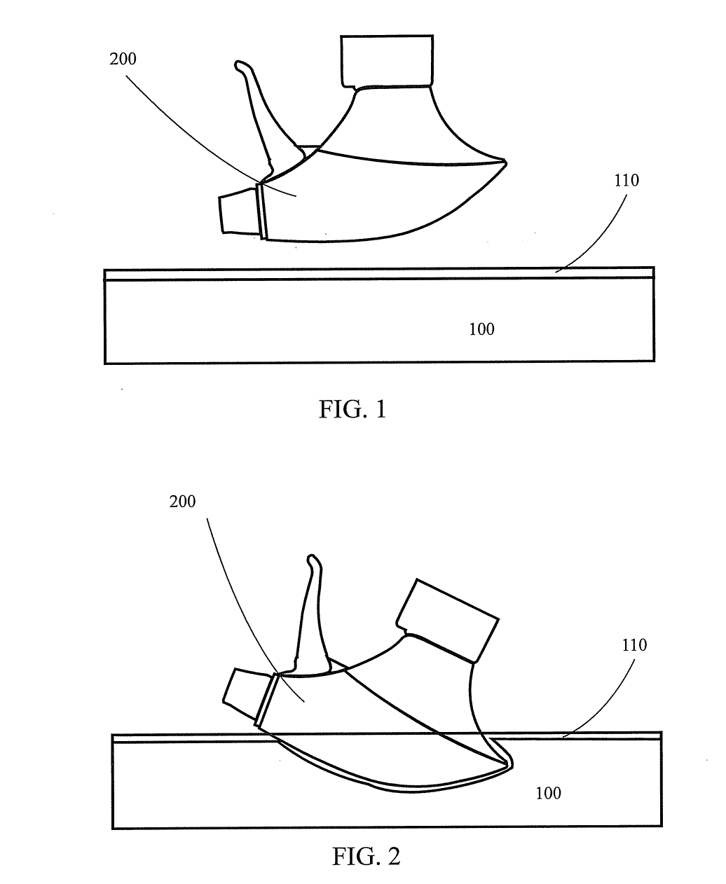

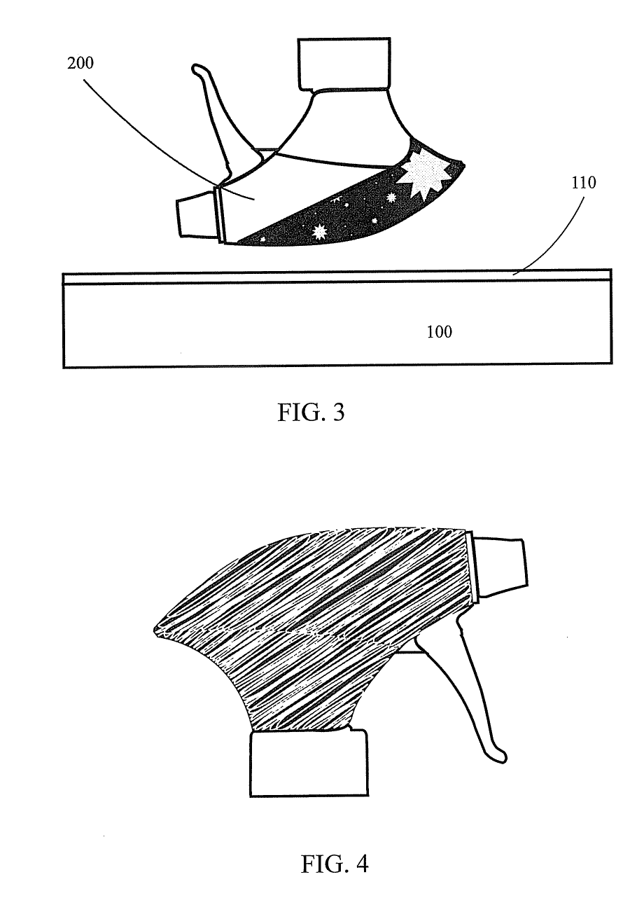

FIGS. 1 through 3 illustrate a water-transfer process that may be used to apply one or more decorative patterns to a surface of a trigger sprayer shroud according to particular embodiments of the invention. As illustrated in FIG. 1, an image transfer film is floated on water and the film is dissolved according to conventional processes, leaving ink 110 floating on the surface of the water 100. A shroud 200 may then be dipped into the water 100 through the ink 110 as illustrated in FIG. 2. Portions of the surface of the shroud 200 come into contact with the ink 110 and the ink 110 adheres to the shroud 200 surface. When the shroud 200 is removed from the water 100 as illustrated in FIG. 3, at least some of the ink 110 is also removed, forming a pattern on the shroud 200. The pattern of ink 110 on the shroud 200 may then be washed and dried, setting the pattern on the shroud 200 surface and forming a decorative trigger sprayer shroud.

According to other embodiments of the invention, a trigger sprayer shroud may be decorated as illustrated in FIG. 4. The trigger sprayer shroud illustrated in FIG. 4 includes a decorative surface wherein a printed decoration is applied to the surface of the trigger sprayer shroud, for example by a water-transfer process. The decoration on the trigger sprayer shroud may include any desired decoration, including one or more wood grain patterns, camouflage patterns, stone patterns, marble patterns, metal patterns, or other decorative patterns. In other embodiments of the invention, the decorative pattern may be applied to a trigger sprayer shroud using methods other than water-transfer printing.

According to certain embodiments of the invention, a decorative trigger sprayer shroud may include a trigger sprayer shroud having one or more camouflage patterns printed on at least a portion of a surface of the trigger sprayer shroud. In other embodiments of the invention, a decorative trigger sprayer shroud may include a trigger sprayer shroud having one or more wood grain patterns printed on at least a portion of a surface of the trigger sprayer shroud. In still other embodiments of the invention, a decorative trigger sprayer shroud may include a trigger sprayer shroud having one or more rock, granite, or marble patterns printed on at least a portion of a surface of the trigger sprayer shroud. In still further embodiments of the invention, a decorative trigger sprayer shroud may include a trigger sprayer shroud having one or more metal patterns printed on at least a portion of a surface of the trigger sprayer shroud.

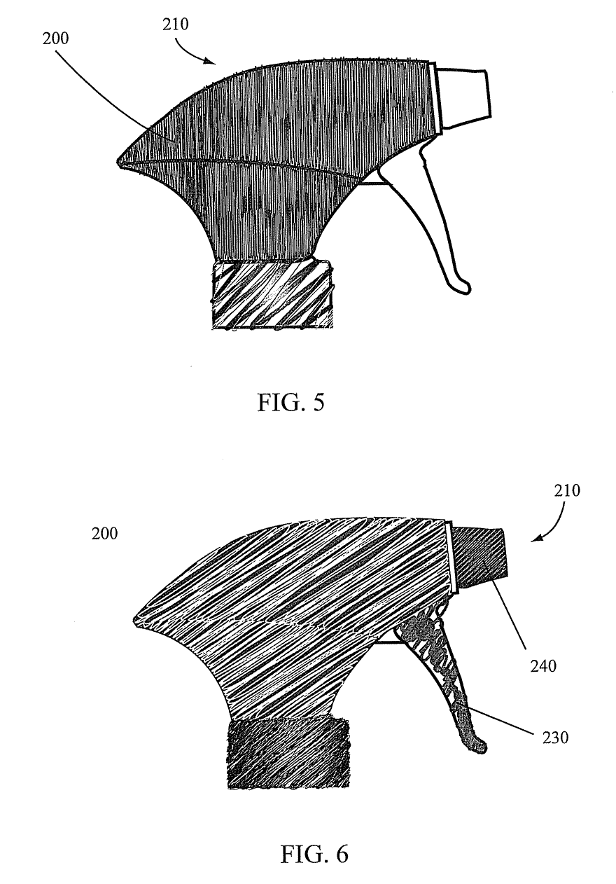

According to other embodiments of the invention, a water-transfer process may be used to transfer a decoration or pattern onto any one of a pump, a pump head, a trigger for a trigger sprayer shroud, a closure device, a bayonet closure device, a trigger of a trigger sprayer, a nozzle used on a trigger sprayer or with a pump, or a dip tube. For example, FIGS. 5 and 6 illustrate decorated trigger sprayer shrouds 200 according to embodiments of the invention assembled in a trigger sprayer 210 also having a decorative closure device 220. In addition, the trigger 230 and nozzle 240 in FIG. 6 are also decorated, for instance, according to embodiments of the invention.

Having thus described certain particular embodiments of the invention, the invention is not limited to these described embodiments. Rather, the invention is limited only by the appended claims, which include within their scope all equivalent devices or methods which operate according to the principles of the invention as described.

What is claimed is:

1. A trigger sprayer, comprising:
a trigger sprayer shroud; and
at least one pattern on a surface of the trigger sprayer shroud, wherein the at least one pattern was formed by a water-transfer process.

2. The trigger sprayer of claim 1, wherein the at least one pattern comprises at least one pattern selected from the group consisting of wood grain patterns, camouflage patterns, stone patterns, marble patterns, metal patterns, and other decorative patterns.

3. A trigger sprayer device, comprising:
a pump;
a trigger in communication with the pump and configured to actuate the pump;
a nozzle in communication with the pump;
a shroud covering at least a portion of the pump; and
at least one decorative water-transfer pattern applied to a surface of the shroud.

4. The trigger sprayer device of claim 3, wherein the at least one decorative water-transfer pattern comprises at least one pattern selected from the group consisting of wood grain patterns, camouflage patterns, stone patterns, marble patterns, metal patterns, and other decorative patterns.

5. The trigger sprayer device of claim 3, wherein the at least one decorative water-transfer pattern applied to a surface of the shroud comprises a decorative pattern applied by a water-transfer process to the surface of the shroud.

6. The trigger sprayer device of claim 3, wherein the pump further comprises a pump having at least one decorative pattern applied to a surface of the pump.

7. The trigger sprayer device of claim 3, wherein the nozzle further comprises a nozzle having at least one decorative pattern applied to a surface of the nozzle.

8. The trigger sprayer device of claim 3, wherein the trigger further comprises a trigger having at least one decorative pattern applied to a surface of the trigger.

9. The trigger sprayer device of claim 3, wherein the at least one decorative pattern is a camouflage pattern.

10. The trigger sprayer device of claim 3, wherein the at least one decorative pattern is a wood grain pattern.

11. The trigger sprayer device of claim 3, wherein the at least one decorative pattern is a metal pattern.

12. The trigger sprayer device of claim 3, wherein the at least one decorative pattern is a pattern selected from the group consisting of a rock pattern, a marble pattern, and a granite pattern.
